(19) United States
(12) Patent Application Publication
(10) Pub. No.: US 2026/0327356 A1
(43) Pub. Date: Oct. 22, 2026

(54) TERT-BUTANOL COSOLVENT IN THE PRODUCTION OF ETHYLENE ACID COPOLYMER

(71) Applicant: Dow Global Technologies LLC, Midland, MI (US)

(72) Inventors: Ivan A. Konstantinov, Pearland, TX (US); David Koenigs, Pearland, TX (US); Sean W. Ewart, Pearland, TX (US); Bruce M. Hasch, Pearland, TX (US); Christopher R. Eddy, Lake Jackson, TX (US); Shannon Duffy Meerscheidt, Missouri City, TX (US); Paul Stanzione, Philadelphia, PA (US)

(73) Assignee: Dow Global Technologies LLC, Midland, MI (US)

(21) Appl. No.: 19/114,999

(22) PCT Filed: Sep. 28, 2023
(86) PCT No.: PCT/US2023/075364

§ 371 Date: Mar. 25, 2025

Related U.S. Application Data
(60) Provisional application No. 63/411,323, filed on Sep. 29, 2022.

(51) Int. Cl. C08F 210/02

(52) U.S. Cl. CPC C08F 210/02; C08F 2800/20

(57) ABSTRACT

Embodiments of the present disclosure are directed a method for producing ethylene acid copolymer comprising: polymerizing via free-radical polymerization at a pressure of at least 1000 atmospheres (atm) a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed, and wherein the ethylene acid copolymer has a melt index (I2) less than 35 dg/min as determined according to ASTM D1238 (at 190° C., 2.16 kg).

### CROSS-REFERENCE TO RELATED APPLICATIONS

This application claims the benefit of U.S. Provisional Application Ser. No. 63/411,323 filed Sep. 29, 2022, the entire disclosure of which is hereby incorporated herein by reference.

### TECHNICAL FIELD

Embodiments described herein generally relate to ethylene acid copolymer and specifically relate to the use of tert-butanol solvent to reduce phase separation and corrosion.

### BACKGROUND

With ethylene acid copolymers, phase separation within the free radical solution mixture is problematic because it can limit acid incorporation in the polymer. Moreover, as the amount of acid in the polymer chains increases, phase separation may cause fouling and gel issues. Thus, methanol cosolvents are conventionally used to reduce phase separation. However, high amounts of methanol may increase corrosion. Furthermore, methanol may act as a chain transfer agent to reduce molecular weight capability of the process.

Consequently, there is a need to replace methanol as a cosolvent.

### SUMMARY

Embodiments of the present disclosure meet this need by replacing methanol with a tert-butanol cosolvent that can reduce phase separation as well as reduce polymer chain termination and corrosion. Additionally, another advantage is that residual tert-butanol levels in the ethylene acid copolymer are non-reactive with any added base, thereby preventing acid groups in the polymer chain from being ionomerized.

According to at least one embodiment of the present disclosure, a method for producing ethylene acid copolymer is provided. The method comprises polymerizing via free-radical polymerization at a pressure of at least 1000 atmospheres (atm) a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed, and wherein the ethylene acid copolymer has a melt index (I2) less than 35 dg/min as determined according to ASTM D1238 (at 190° C., 2.16 kg).

According to another embodiment, the method comprises polymerizing via free-radical polymerization at a pressure of at least 1000 atmospheres (atm) and a reaction temperature of greater than 200° C., a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed.

These and other embodiments are described in more detail in the following drawings and Detailed Description.

### BRIEF DESCRIPTION OF THE DRAWINGS

FIG. 1 is a graphical plot of the cloud point data for Example 1; and

FIG. 2 is a graphical plot of the cloud point data for Example 2;

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

“Ethylene acid copolymer” is a polymerized reaction product of ethylene and one or more unsaturated carboxylic acid containing monomers.

Embodiments are directed to a method for producing ethylene acid copolymer comprising polymerizing via free-radical polymerization at a pressure of at least 1000 atmospheres (atm) a feed comprising ethylene monomer, unsaturated carboxylic acid containing comonomer, and co-solvent to produce the ethylene acid copolymer. The co-solvent comprises tert-butanol. The co-solvent may comprise less than 15 wt. % of the feed. In other embodiments, the co-solvent comprises from 5 to 14 wt. %, or from 7 to 13 wt. %.

In one or more embodiments, the polymerization is conducted in the presence of a free radical initiator. A typical amount of free radical initiator is from about 0.1 to about 5, about 0.2 to about 2, or from about 0.25 to about 1% by weight, based on the weight of the feed. Another typical amount of free radical initiator may be from about 50 ppm to about 2,500 ppm, from about 100 ppm to about 1,000 ppm, or from about 150 ppm to about 500 ppm by weight, based on the weight of the feed. The free radical initiator may be all added at the start of the reaction, or it may be added continuously or in stages during the reaction (particularly when the monomer is so added). Examples of suitable free radical initiators include peroxyesters, peroxides, persulfates, perborates, percarbonates, azo compounds and the like. Specific examples of suitable free radical initiators include hydrogen peroxide, tert-butyl peroctoate, tert-butyl peracetate, di(t-butyl) peroxide, lauroyl peroxide, cumene hydroperoxide, t-butyl hydroperoxide, 2,2′-azobis [2,4-dimethyl]pentanenitrile, 2-(t-butylazo)-2-methylbutane nitrile, 2-(t-butylazo)-2-4, dimethylpentanenitrile, azobis(isobutyronitrile), azobis(methylbutyronitrile) (AMBN), tert-amyl peroxy 2-ethyl hexanoate and mixtures of any two or more thereof.

In one or more embodiments, the polymerization, which may optionally be performed with the above free radical initiators, may be performed at a temperature less than equal to 230° C., less than 220° C., or less than 210° C. Moreover, the polymerization may be performed at a temperature ranging from 175 to 230° C., from 200 to 230° C., or from 210 to 230° C. In an exemplary embodiment, the polymerization may utilize t-butyl peroctoate at a temperature ranging from 175 to 230° C.

In alternative embodiments, polymerization may be performed at a temperature greater than 180° C., greater than 200° C., greater than 220° C., greater than 230° C., or greater than 240° C. Moreover, the polymerization may be performed at a temperature ranging from 230 to 280° C., from 230 to 260° C., or from 240 to 250° C. In an exemplary embodiment, the polymerization may utilize t-butyl peracetate at temperature ranging from 230 to 280° C.

In embodiments, the unsaturated carboxylic acid containing comonomer may include unsaturated monocarboxylic acids such as acrylic acid, methacrylic acid, or combinations thereof. In embodiments, the unsaturated carboxylic acid containing comonomer may be present in an amount of from 5 wt. % to 35 wt. %, from 12 wt % to 30 wt. %, from 15 wt. % to 25 wt. %, or from 21 wt. % to 25 wt. % based on a total weight of the monomers present in the ethylene acid copolymer. Conversely, the ethylene content of the ethylene acid copolymer is greater than 50 wt. %, or greater than 60 wt. %. For example, the ethylene content of the ethylene acid copolymer is from 50 wt. % to 95 wt. %, from 70 wt. % to 88 wt. %, from 75 wt. % to 85 wt. %, or from 75 wt. % to 79 wt. %.

In embodiments, the ethylene acid copolymer may have a melt index (I₂) of from 1 to 2000 dg/10 min, from 1 to 300 dg/10 min, from 20 to 100 dg/10 min, from 1 to 35 dg/10 min, from 25 to 35 dg/10 min, from 125 to 300 dg/10 min, from 200 to 275 dg/10 min, or from 250 to 275 dg/10 min, as measured according to ASTM D-1238 (190° C./2.16 Kg). In another embodiment, the ethylene acid copolymer has a melt index (I₂) less than 35 dg/min.

As stated above, the co-solvent may comprise tert-butanol. In addition to co-solvent, the feed may also comprise solvent. In one embodiment, the solvent may include supercritical ethylene. In this case, the supercritical ethylene may act as solvent and monomer for the ethylene acid copolymer polymerization. The solvent may also include hydrocarbon solvents, which may include, but are not limited to, mineral solvents, e.g. from mineral oils, normal paraffinic solvents, isoparaffinic solvents, cyclic solvents, and the like. The hydrocarbon solvents may, for example, be selected from the group consisting of n-octane, iso-octane (2,2,4-trimethylpentane), n-dodecane, iso-dodecane (2,2,4,6,6-pentamethylheptane), and other isoparaffinic solvents. The solvent may be present in the mixture at less than 99 wt. %, from 5 to 95 wt. %, from 5 to 90 wt. %, or from 10 to 90 wt. %.

The free radical polymerization process is generally known in the art. Generally, the process is conducted at elevated temperatures and pressures in either a batch-wise process or continuous manner. Suitable reactors such as tubular reactors or autoclave reactors are familiar to the person of skill in the art. Additionally, compressor units upstream of the reactors and separator units downstream of the reactors are also familiar to the skilled person. The polymerization pressure may be in the range of at least 1000 atm (101.3 MPa or 1013.25 bar), from 1000 to 5000 atm, from 1200 to 4000 atm, or from 1500 to 3500 atm. The polymerization temperature is typically in the range of about 70° C. to about 380° C. All individual values and subranges in the range of about 70° C. to about 380° C. are included herein and disclosed herein; for example, polymerization temperature is in the range of 100° C. to 300° C., or from 150° C. to 250° C. It is noted that some reactor designs use multiple zones to achieve effective polymerization; the temperature ranges here are applicable to any individual zone in a multi-zone reactor.

In addition to the above-described components, additional additives such as inhibitors, chain transfer agents, radical scavengers, and the like are also contemplated as being part of the mixture fed to the reactor.

### Test Methods

Melt Index (190° C., 2.16 kg, “I₂”) Test Method: ASTM D 1238-13, Standard Test Method for Melt Flow Rates of Thermoplastics by Extrusion Plastometer, using conditions of 190° C./2.16 kilograms (kg). Results were reported in units of grams eluted per 10 minutes (g/10 min.) or the equivalent in decigrams per 1.0 minute (dg/1 min.).

### EXAMPLES

The following examples illustrate features of the present disclosure but are not intended to limit the scope of the disclosure.

### Cloud Point Experiments

An optical cell was used to measure the cloud point curves for each cosolvent in accordance with the experimental method published in Macromol. Chem. Phys., 2003, 204, 638-645. Cloud point is the temperature and pressure below which a solution phase-separates. The experimental solutions included 10 wt. % ethylene acid copolymer, supercritical ethylene solvent, cosolvents listed in Table 1 at various weight percentages, and 0.5 wt. % BHT (butylated hydroxytoluene) inhibitor. The solutions were placed in the optical cell and heated to the desired temperature, which as shown was in the range of 178 to 240° C. The cell was then pressurized above the cloud point to ensure it was in the single phase (homogeneous) regime. Pressure was then lowered until the cloud point was found. The optical cell was then heated to the next temperature point.

The ethylene acid copolymers utilized in the Examples were prepared by standard free-radical copolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference.

TABLE 1
Cosolvents

| | Boiling Point (°C) | |
|---|---|---|
| Cosolvent | at 1 atm | |
| Methanol | 64.7 | °C |
| Formic Acid | 100.8 | °C |
| Acetic Acid | 118 | °C |
| Pivalic Acid | 163.8 | °C |
| Tert-butanol | 117.7 | °C |

### Example 1

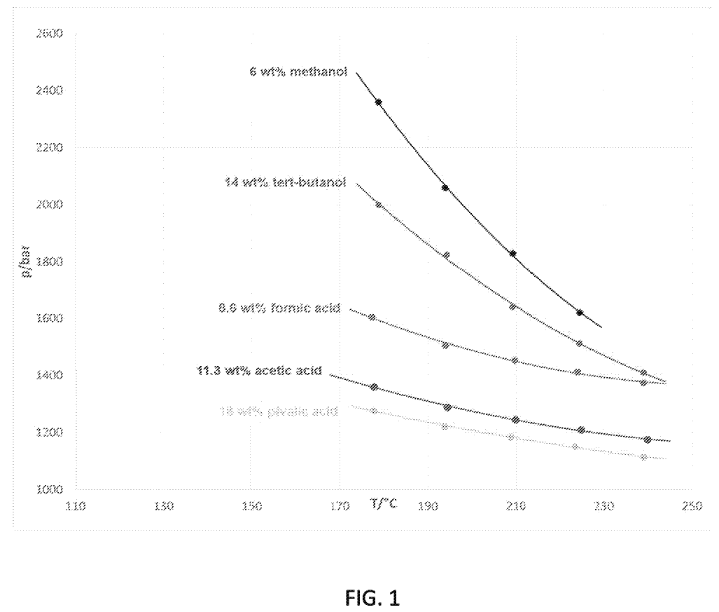

For Example 1 as shown in Table 2 and FIG. 1, the ethylene acid copolymer comprised 19 wt. % methacrylic acid comonomer and a melt index (I₂) of 60 g/10 mins. Various cosolvent amounts were utilized with the amount of cosolvent chosen to be equimolar to 6 wt. % methanol. As shown, the cloud point pressure values at each temperature point were lower than the methanol. As stated above, this is advantageous as there will not be phase separation at lower temperatures and pressures as in the case of methanol.

TABLE 2

| Cosolvent | T(°C)/P(bar) | T(°C)/P(bar) | T(°C)/P(bar) | T(°C)/P(bar) | T(°C)/P(bar) |
|---|---|---|---|---|---|
| 6 wt. % | 178.8/2360 | 193.9/2060 | 209.2/1830 | 224.5/1620 | |
| Methanol | | | | | |
| 8.6 wt. % | 177.4/1605 | 194/1505 | 209.6/1453 | 224/1413 | 238.9/1374 |
| Formic Acid | | | | | |
| 11.3 wt. % | 177.8/1360 | 194.4/1288 | 209.8/1246 | 224.8/1210 | 239.9/1175 |
| Acetic Acid | | | | | |
| 14 wt. % | 178.8/2000 | 194.2/1825 | 209.1/1640 | 224.4/1513 | 238.9/1410 |
| Tert-butanol | | | | | |
| 18 wt. % | 177.8/1276 | 193.7/1222 | 208.7/1184 | 223.5/1150 | 239/1114 |
| Pivalic Acid | | | | | |

### Example 2

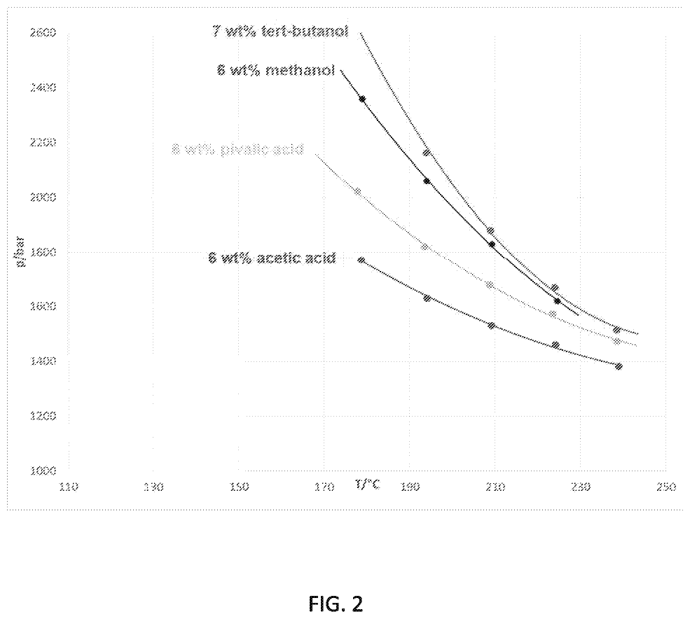

For Example 2 as shown in Table 3 and FIG. 2, the same ethylene acid copolymer as Example 1 was used with various cosolvents added at 6 wt. %. Because tert-butanol has molecular weight of 74.12 g/mol and methanol has molecular weight of 32.04 g/mol, at the same mass loading, there are fewer moles of tert-butanol in the system.

TABLE 3

| Cosolvent | T(°C)/P(bar) | T(°C)/P(bar) | T(°C)/P(bar) | T(°C)/P(bar) | T(°C)/P(bar) |
|---|---|---|---|---|---|
| 6 wt. % | 178.8/2360 | 193.9/2060 | 209.2/1830 | 224.5/1620 | |
| Methanol | | | | | |
| 6 wt. % | 178.6/1771 | 194/1630 | 209.1/1530 | 224.1/1460 | 238.9/1381 |
| Acetic Acid | | | | | |
| 6 wt. % | 177.7/2023 | 193.4/1820 | 208.7/1678 | 223.4/1572 | 238.5/1473 |
| Pivalic Acid | | | | | |
| 7 wt. % tert - | 178.6/2605 | 193.8/2163 | 208.9/1880 | 223.9/1669 | 238.4/1515 |
| butanol | | | | | |

### Example 3

TABLE 4

| | | | | | | | Tert- | Melt Index |
|---|---|---|---|---|---|---|---|---|
| | T_{feed} | T_{reactor} | P_{reactor} | MAA | Methanol | | Butanol | (I₂) |
| Sample | (°C) | (°C) | (psig) | (%) | (%) | Initiator | (%) | (g/10 mins) |
| Inventive | 40 | 220 | 27,000 | 21.7 | | Tert-butyl | 13 wt % | ~29 |
| Example 1 | | | | | | peroctoate | | |
| Inventive | 40 | 248 | 27,000 | 19.0 | | Tert-butyl | 7 wt % | ~265 |
| Example 2 | | | | | | peracetate | | |
| Comparative | 40 | 220 | 27,000 | 21.7 | 6 wt % | Tert-butyl | | ~117 |
| Example 3 | | | | | | peroctoate | | |

Referring to Table 4, additional samples were processed with tert-butanol and methanol to show the increased molecular weight achievable when using tert-butanol cosolvent versus methanol cosolvent. As shown, Comparative Example 3 involved the production of 21.7 wt % MAA copolymer at 220° C. and 27,000 psi. The resulting material had a melt index (12) of approximately 117 g/10 mins. In contrast as shown for Inventive Example 1, to achieve single-phase reactor operation for the production of the same material, 13 wt % tert-butanol was needed but the resulting melt index was significantly lower (~29). The lower melt index corresponds to higher molecular weight, which indicates that tert-butanol provides less of a chain-transfer effect by not undesirably terminating polymer chains like methanol. Moreover, as shown in Inventive Example 2, a clean reactor operation (very low fouling) and single phase operation for 19 wt % MAA copolymer was achieved at 248° C. and 2,7000 psi with 7 wt % tert-butanol.

### Example 4—Corrosion Data

For the corrosion study, a 40 mL glass vial was charged with tetradecane, a carbon steel coupon, methacrylic acid, and cosolvent (methanol or tert butanol). Total mass inside the vial excluding the mass of the carbon steel coupon equaled 10 g. The vial was heated to 100° C. for 7 days. After that, the vial was allowed to cool to ambient temperature and the carbon steel coupon was removed. The amount of corrosion was determined by mass balance/weight loss of the carbon steel coupon and is provided in Table 6.

TABLE 6

| | | | | | Weight |
|---|---|---|---|---|---|
| | Tetra- | Methacrylic | | Tert | Loss of |
| | decane | Acid | Methanol | butanol | Carbon Steel |
| Coupon | (g) | (g) | (g) | (g) | Coupon (mg) |
| 1 | 8 | 2 | — | — | 13.0 |
| 2 | 7.5 | 2 | 0.5 | — | 80.3 |
| 3 | 7 | 2 | 1 | — | 94.9 |
| 4 | 7.5 | 2 | — | 0.5 | 20.1 |
| 5 | 7 | 2 | — | 1 | 18.6 |
| 6 | 9 | — | 1 | — | <1.0 |
| 7 | 9 | — | — | 1 | <1.0 |

As shown for Coupon samples 6 and 7, methanol or tert-butanol alone do not show significant corrosion of the carbon steel coupon (<1.0 mg loss of mass). As shown for Coupon 1, the baseline of only methacrylic acid shows loss of mass equal to 13.0 mg. This can be considered a normal background corrosion coming from the fact that methacrylic acid is always present in the process. For comparative Coupon 2, the combination of methacrylic acid and methanol results in a significantly increased corrosion. The two experiments of 2 g methacrylic acid and 0.5 g methanol (comparative Coupon 2) and 2.0 g methacrylic acid and 1.0 g methanol (comparative Coupon 3) produced 80 mg and 95 mg of coupon mass loss, respectively. While methanol itself is not corrosive, the combination with methacrylic acid drastically increases corrosion on carbon steel. In contrast as shown in inventive Coupon samples 4 and 5, tert-butanol resulted in less corrosion in combination with methacrylic acid, producing coupon mass losses of 20 mg and 19 mg, respectively. Thus, improved corrosion was achieved by replacing methanol with tert-butanol as the cosolvent in addition to the other benefits tert-butanol delivers e.g., increased molecular weight.

The embodiments herein may include one or more aspects. According to a first aspect, a method for producing ethylene acid copolymer comprising polymerizing via free-radical polymerization at a pressure of at least 1000 atmospheres (atm) a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed, and wherein the ethylene acid copolymer has a melt index (I2) less than 35 dg/min as determined according to ASTM D1238 (at 190° C., 2.16 kg).

A second aspect includes any preceding aspect, wherein the polymerization is performed at a temperature of less than or equal to 230° C.

A third aspect includes any preceding aspect, wherein the ethylene acid copolymer comprises from 5 to 35 wt. %, or from 12 to 25 wt. % unsaturated carboxylic acid containing comonomer incorporated therein.

A fourth aspect includes any preceding aspect, wherein the ethylene acid copolymer comprises a melt index (I₂) from 1 to 35 dg/min as measured according to ASTM D-1238 (190° C./2.16 Kg).

A fifth aspect includes any preceding aspect, wherein the unsaturated carboxylic acid containing comonomer comprises acrylic acid, methacrylic acid, or combinations thereof.

A sixth aspect includes any preceding aspect, wherein the polymerization is performed in the presence of a free radical initiator.

According to a seventh aspect, a method for producing ethylene acid copolymer comprising polymerizing via free-radical polymerization at a pressure of at least 1000 atmospheres (atm) and a reaction temperature of greater than 200° C. a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed.

An eighth aspect includes the seventh aspect, wherein the polymerization is performed at a temperature greater than 220° C., greater than 230° C., or greater than 240° C.

A ninth aspect includes the seventh through eighth aspects, wherein the ethylene acid copolymer comprises a melt index (I₂) from 1 to 2000 dg/min as measured according to ASTM D-1238 (190° C./2.16 Kg).

A tenth aspect includes the seventh through ninth aspects, wherein the ethylene acid copolymer comprises from 5 to 35 wt. %, or from 12 to 25 wt. % unsaturated carboxylic acid containing comonomer incorporated therein.

An eleventh aspect includes the seventh through tenth aspects, wherein the unsaturated carboxylic acid containing comonomer comprises acrylic acid, methacrylic acid, or combinations thereof.

A twelfth aspect includes the seventh through eleventh aspects, wherein the polymerization is performed in the presence of a free radical initiator.

A thirteenth aspect includes the first through sixth aspects, wherein the polymerization is performed at a temperature in any reaction zone of a single or multi-zone reactor which is less than or equal to 230° C.

A fourteenth aspect includes the seventh through eleventh aspects, wherein the polymerization is performed in any reaction zone of a single or multi-zone reactor at the reaction temperature.

According to a fifteenth aspect, a method for producing ethylene acid copolymer comprising polymerizing via free-radical polymerization at a pressure of at least 1000 atmospheres (atm) and a reaction temperature of greater than 180° C. in any reaction zone of a single or multi-zone reactor, a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A method for producing ethylene acid copolymer comprising:
polymerizing via free-radical polymerization at a pressure of at least 1000 atmospheres (atm) a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed, and
wherein the ethylene acid copolymer has a melt index (I₂) less than 35 dg/min as determined according to ASTM D1238 (at 190° C., 2.16 kg).

2. The method of claim 1, wherein the polymerization is performed at a temperature of less than or equal to 230° C.

3. The method of claim 1, wherein the ethylene acid copolymer comprises from 5 to 35 wt. %, or from 12 to 25 wt. % unsaturated carboxylic acid containing comonomer incorporated therein.

4. The method of claim 1, wherein the ethylene acid copolymer comprises a melt index (I₂) from 1 to 35 dg/min as measured according to ASTM D-1238 (190° C./2.16 Kg).

5. The method of claim 1, wherein the unsaturated carboxylic acid containing comonomer comprises acrylic acid, methacrylic acid, or combinations thereof.

6. The method of claim 1, wherein the polymerization is performed in the presence of a free radical initiator.

7. A method for producing ethylene acid copolymer comprising:
polymerizing via free-radical polymerization at a pressure of at least 1000 atmospheres (atm) and a reaction temperature of greater than 200° C. a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed.

8. The method of claim 7, wherein the polymerization is performed at a temperature greater than 220° C., greater than 230° C., or greater than 240° C.

9. The method of claim 7, wherein the ethylene acid copolymer comprises a melt index (I₂) from 1 to 2000 dg/min as measured according to ASTM D-1238 (190° C./2.16 Kg).

10. The method of claim 7, wherein the ethylene acid copolymer comprises from 5 to 35 wt. %, or from 12 to 25 wt. % unsaturated carboxylic acid containing comonomer incorporated therein.

11. The method of claim 7, wherein the unsaturated carboxylic acid containing comonomer comprises acrylic acid, methacrylic acid, or combinations thereof.

12. The method of claim 7, wherein the polymerization is performed in the presence of a free radical initiator.

13. The method of claim 1, wherein the polymerization is performed at a temperature in any reaction zone of a single or multi-zone reactor which is less than or equal to 230° C.

14. The method of claim 7, wherein the polymerization is performed in any reaction zone of a single or multi-zone reactor at the reaction temperature.

15. A method for producing ethylene acid copolymer comprising:
polymerizing via free-radical polymerization at a pressure of at least 1000 atmospheres (atm) and a reaction temperature of greater than 180° C. in any reaction zone of a single or multi-zone reactor, a feed comprising ethylene monomer, unsaturated carboxylic acid containing comonomer, and co-solvent to produce the ethylene acid copolymer, wherein the co-solvent comprises tert-butanol and wherein the co-solvent comprises less than 15 wt. % of the feed.
